(19) United States
(12) Patent Application Publication
(10) Pub. No.: US 2006/0257614 A1
(43) Pub. Date: Nov. 16, 2006

(54) Optical information storage medium

(75) Inventors: Zhi-Zhong Wang, Changhua County (TW); Han-Yi Chang, Taipei County (TW); Cheng-Yuan Tsai, Tzu-Bei City (TW)

Correspondence Address: BIRCH STEWART KOLASCH & BIRCH, PO BOX 747, FALLS CHURCH, VA, 22040-0747, US

(73) Assignee: PRODISC TECHNOLOGY INC.

(21) Appl. No.: 11/158,084

(22) Filed: Jun. 22, 2005

(30) Foreign Application Priority Data
May 11, 2005 (TW) 094115299

(51) Int. Cl. B32B 3/02

(52) U.S. Cl. 428/64.4

(57) ABSTRACT

An optical information storage medium includes a first substrate, a first recording layer, a first reflective layer, a spacer layer, a buffer layer, a second recording layer, a second reflective layer, and a second substrate. In this case, the first recording layer is disposed above the first substrate. The first reflective layer is disposed above the first recording layer. The spacer layer is disposed above the first reflective layer. The buffer layer is disposed above the spacer layer, and the thickness of the buffer layer is about between 1 nm and 50 nm. The second recording layer is disposed above the buffer layer. The second reflective layer is disposed above the second recording layer. The second substrate is disposed above the second reflective layer.

### BACKGROUND OF THE INVENTION

1. Field of Invention

The invention relates to an optical information storage medium and, in particular, to an optical information storage medium with a high storage density.

2, Related Art

Due to the progress of multimedia, the demands of storage medium in 3C products, i.e. computer, communication and consumer, regarding to storage density and capacity are increasing. Conventional storage medium could be divided into magnetic information storage medium and optical information storage medium. Optical information storage medium is greatly applied to electronic products, it includes read-only CD (CD-ROM), write-once CD (CD-R), rewritable CD (CD-RW), read-only DVD (DVD-ROM), write-once DVD (DVD-R), rewritable DVD (DVD-RW, DVD+RW) and random-access DVD (DVD-RAM), etc.

In order to store much more audio, video and other information, how to increase the storage capacities of CD and DVD has been an important target in this industry. Due to the advantage of high storage capacity, DVD will have higher potential than CD being applied to electronic products. DVD has different configuration such as single-side single-layer, dual-side single-layer, single-side dual-layer and dual-side dual-layer, and the storage capacity ranges from 4.7 GB to 17 GB.

Due to the properties of high storage capacity (8.5 GB) and write-once, the application of single-side dual-layer DVD-R is more and more important. As shown in FIG. 1, a conventional single-side dual-layer DVD-R 10 includes a first substrate 11, a first recording layer 12, a first reflective layer 13, a spacer layer 14, a second recording layer 16, a second reflective layer 17, and a second substrate 18. The first recording layer 12 and the first reflective layer 13 compose a first recording stack layer (L₀), and the second recording layer 16 and the second reflective layer 17 compose a second recording stack layer (L₁). The first recording stack layer (L₀) and the second recording stack layer (L₁) are respectively formed on the data side of the first substrate 11 and the second substrate 18. The spacer layer 13 is disposed between the first recording stack layer (L₀) and the second recording stack layer (L₁). When reading out data stored in DVD-R, the laser beam will pass through the first substrate 11 and focus on the first recording stack layer or pass through the spacer layer 14 and focus on the second recording stack layer.

In the prior art, the manufacturing method of the single-side dual-layer DVD-R 10 having larger data storage capacity includes the photo-polymerization process (2P process) and the inversed stack process (so called bonding process). Since the photo-polymerization process includes the steps for pressing and striping the stamper, the product yield may be reduced. Besides, the stamper is expansive, so that the manufacturing cost with utilizing the photo-polymerization process is higher than that with utilizing the inversed stack process. Therefore, utilizing the inversed stack process to manufacture the single-side dual-layer DVD-R becomes the trend of this industry.

Referring to FIG. 2, when utilizing the inversed stack process to manufacture the single-side dual-layer DVD-R, the second recording layer 16 and the spacer layer 14 should be insulated to prevent the reaction between the dye in the second recording layer 16 and the unhardened spacer layer 14. Thus, a buffer layer 15 is formed between the second recording layer 16 and the spacer layer 14. In general, the buffer layer 15 is formed by sputtering.

However, if the buffer layer 15 is too thick, the reflective ratio of the second recording stack layer may be accordingly reduced. Once the reflective ratio is down to 16%, which is the minimum requirement of the optical pickup, the DVD-R can not be accessed. In other words, the product yield of the DVD-R is decreased. In addition, if the thickness of the buffer layer 15 is insufficient, the second recording layer 16 may contact with the unhardened spacer layer 14 (resin) and the undesired reaction occurs. In this case, the buffer layer 15 can not protect the second recording layer 16. Therefore, how to find the appropriate thickness of the buffer layer 15 to cooperate with the thickness of the second recording layer 16, which results in the better product yield of the single-side dual-layer DVD-R with the inversed stack process and the second recording stack layer conforming the requirement of the optical pickup for the reflective ratio (16%), has been an essential issue in this industry.

It is therefore an important subject of the present invention to provide an optical information storage medium for solving the problem of the conventional optical information storage medium with the buffer layer that the second recording stack layer does not have sufficient reflective ratio.

### SUMMARY OF THE INVENTION

In view of the foregoing, the invention is to provide an optical information storage medium, which can be manufactured by the inversed stack process and have a second recording stack layer with a reflective ration larger than 16% resulting in the normal access thereof.

To achieve the above, an optical information storage medium of the invention includes a first substrate, a first recording layer, a first reflective layer, a spacer layer, a buffer layer, a second recording layer, a second reflective layer, and a second substrate. In the invention, the first recording layer is disposed above the first substrate. The first reflective layer is disposed above the first recording layer. The spacer layer is disposed above the first reflective layer. The buffer layer is disposed above the spacer layer, and the thickness of the buffer layer is about between 1 nm and 50 nm. The second recording layer is disposed above the buffer layer. The second reflective layer is disposed above the second recording layer. The second substrate is disposed above the second reflective layer.

As mentioned above, the thickness of the buffer layer in the optical information storage medium of the invention is about between 1 nm and 50 nm. Compared with the prior art, the optical information storage medium of the invention includes a buffer layer, which is disposed between the second recording layer and the spacer layer, having a thickness of about 1 nm to 50 nm for protecting the second recording layer from reacting with the unhardened material of the spacer layer. In addition, the buffer layer may provide a block function for preventing the moisture and oxygen from entering into the second recording layer. Besides, when the optical information storage medium is rotated in a high speed, the buffer layer can serve as a heat-dissipation medium of the second recording stack layer.

### BRIEF DESCRIPTION OF THE DRAWINGS

The invention will become more fully understood from the detailed description given herein below illustration only, and thus is not limitative of the present invention, and wherein:

FIG. 1 is a schematic view showing the conventional single-side dual-layer DVD-R;

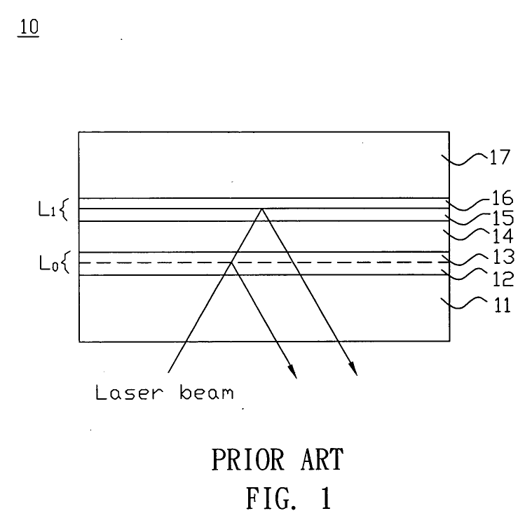

FIG. 2 is a schematic illustration showing the inversed stack process for manufacturing the conventional single-side dual-layer DVD-R; and

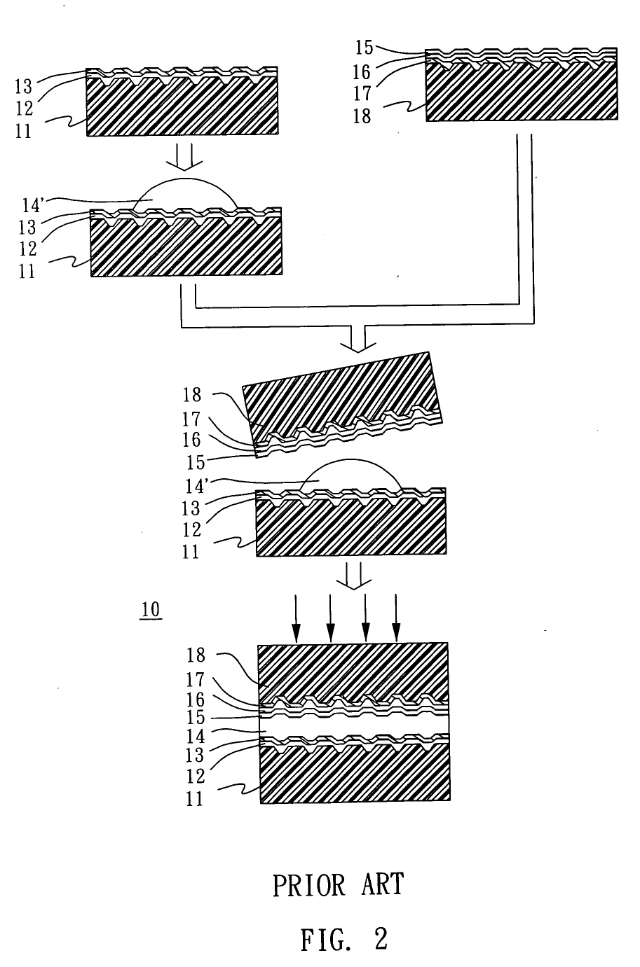

FIG. 3 is a schematic view showing an optical information storage medium according to a preferred embodiment of the invention, wherein the thickness of a buffer layer is about between 1 nm and 50 nm.

### DETAILED DESCRIPTION OF THE INVENTION

The present invention will be apparent from the following detailed description, which proceeds with reference to the accompanying drawings, wherein the same references relate to the same elements.

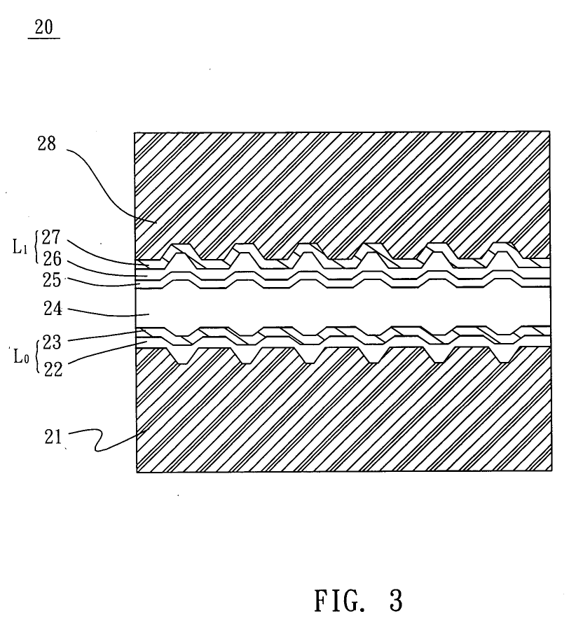

With reference to FIG. 3, an optical information storage medium 20 according to a preferred embodiment of the invention includes a first substrate 21, a first recording layer 22, a first reflective layer 23, a spacer layer 24, a buffer layer 25, a second recording layer 26, a second reflective layer 27, and a second substrate 28. In this embodiment, the optical information storage medium 20 is, for example, a write-once single-side dual-layer DVD and manufactured by inversed stack process.

The first recording layer 22 is disposed above the first substrate 21. The first recording layer 22 may be made of organic dye or inorganic material. In this embodiment, the first recording layer 22 is made of organic dye, such as AZO dye, and formed by a spin-coating process.

The first reflective layer 23 is disposed above the first recording layer 22. In the embodiment, the first reflective layer 33 may be a semi-reflective layer, which is made of metal or its alloy such as, for example but not limited to, silver or silver alloy, aluminum or aluminum alloy, or gold or gold alloy. The formation process of the first reflective layer 23 may be sputtering or evaporation. Generally, the first recording layer 22 and the first reflective layer 23 compose a first recording stack layer L₀.

The spacer layer 24 is disposed above the first reflective layer 23. In the present embodiment, the spacer layer 24 is made of photo-setting resin, which is liquid state at the beginning and photo-cured by radiation or heat to be a solid resin.

The buffer layer 25 is disposed above the spacer layer 24. In this embodiment, the thickness of the buffer layer 25 is about between 1 nm and 50 nm. The buffer layer 25 is usually made of silicon nitride, silicon oxide, zinc sulfide-silicon oxide, or tantalum oxide. Besides, the refractive ratio of the buffer layer 25 is substantially equal to that of the spacer layer 24, so that the light transmittance can be increased.

The second recording layer 26 is disposed above the buffer layer 25. In this case, the second recording layer 26 may be made of an organic dye such as AZO dye and formed by the spin-coating process. In the current embodiment, the thickness of the second recording layer 26 ranges from 90 nm to 170 nm.

The second reflective layer 27 is disposed above the second recording layer 26. The second reflective layer 27 may be a film of semiconductor or conductive alloy. Herein, the second recording layer 26 and the second reflective layer 27 compose a second recording stack layer L₁.

The second substrate 28 is disposed above the second reflective layer 27. In general, the first substrate 21 and the second substrate 28 are made of polycarbonate (PC) with excellent optical property and chemical stability. Of course, the first substrate 21 and the second substrate 28 may be other transparent material.

To make the optical pickup of the optical disc drive access the data stored in the first recording stack layer L₀ and the second recording stack layer L₁ of the single-side dual-layer DVD-R 20, the recording stack layers must satisfy the requirement that the reflective ratio thereof is larger than 16%. In particular, the reflective ratio of the second recording stack layer L₁ must be more critical, so that the optical disc drive can access the data in the second recording stack layer L₁ normally.

In the embodiment, the second recording layer 26 is made of AZO dye and has a thickness of 90 nm to 170 nm. The buffer layer 25 is made of made of silicon nitride, silicon oxide, zinc sulfide-silicon oxide, or tantalum oxide and has a thickness of 1 nm to 50 nm. In this case, if the buffer layer 25 is made of zinc sulfide-silicon oxide, the thickness thereof is about between 1 nm and 40 nm. When the thicknesses of the second recording layer 26 and the buffer layer 25 are properly cooperated, the buffer layer 25 can be disposed between the spacer layer 24 and the second recording layer 26 without influencing the optical property of the second stack layer L₁. In other words, the reflective ratio of the second stack layer L₁ can be larger than 16%. Thus, the product yield of the optical information storage medium of the invention can be increased.

If the buffer layer 25 has appropriate thickness, the reflecting interface of the second stack layer for reflecting the laser beam becomes more planar. This also increases the reflective ratio of the second stack layer L₁.

The buffer layer 25 has a protection function for protect the second recording 26 from interacting with the unhardened spacer layer 24. Besides, the buffer layer 25 further provides a block function for preventing the moisture and oxygen from entering into the second recording layer 26. Moreover, when the optical information storage medium 20 is rotated in a high speed, the buffer layer 25 can serve as a heat-dissipation medium of the second recording stack layer L₁.

In summary, the thickness of the buffer layer in the optical information storage medium of the invention is about between 1 nm and 50 nm. Compared with the prior art, the optical information storage medium of the invention includes a buffer layer, which is disposed between the second recording layer and the spacer layer, having a thickness of about 1 nm to 50 nm for protecting the second recording layer from reacting with the unhardened material of the spacer layer. In addition, the buffer layer may provide a block function for preventing the moisture and oxygen from entering into the second recording layer. Besides, when the optical information storage medium is rotated in a high speed, the buffer layer can serve as a heat-dissipation medium of the second recording stack layer.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An optical information storage medium, comprising:
a first substrate;
a first recording layer, which is disposed above the first substrate;
a first reflective layer, which is disposed above the first recording layer;
a spacer layer, which is disposed above the first reflective layer;
a buffer layer, which is disposed above the spacer layer and has a thickness substantially between 1 nm and 50 nm;
a second recording layer, which is disposed above the buffer layer;
a second reflective layer, which is disposed above the second recording layer; and
a second substrate, which is disposed above the second reflective layer.

2. The medium of claim 1, wherein the optical information storage medium is a single-side dual-layer DVD.

3. The medium of claim 1, wherein the optical information storage medium is formed by an inversed stack process.

4. The medium of claim 1, wherein the material of the buffer layer comprises silicon oxide, silicon nitride, zinc sulfide-silicon oxide, or tantalum oxide.

5. The medium of claim 1, wherein the material of the buffer layer is zinc sulfide-silicon oxide, and the thickness of the buffer layer is substantially between 1 nm and 40 nm.

6. The medium of claim 1, wherein the refraction ratio of the buffer layer is substantially equal to the refraction ratio of the spacer layer.

7. The medium of claim 1, wherein the thickness of the second recording layer is substantially between 90 nm and 170 nm.

8. The medium of claim 1, wherein the material of the second recording layer is an AZO dye.
